(19) United States
(12) Patent Application Publication
(10) Pub. No.: US 2005/0060590 A1
(43) Pub. Date: Mar. 17, 2005

(54) Power-aware workload balancing usig virtual machines

(75) Inventors: David Bradley, Chapel Hill, NC (US); Richard E. Harper, Chapel Hill, NC (US); Steven Wade Hunter, Raleigh, NC (US)

Correspondence Address: Anne Vachon Dougherty, 3173 Cedar Road, Yorktown Heights, NY, 10598, US

(73) Assignee: International Business Machines Corporation, Armonk, NY (US)

(21) Appl. No.: 10/663,285

(22) Filed: Sep. 16, 2003

(51) Int. Cl. G06F 1/32; G06F 1/26

(52) U.S. Cl. 713/320

(57) ABSTRACT

A system and method for utilizing the locale-independence of virtual machine technology is employed to facilitate load imbalancing in support of power management. Arbitrary stateless or stateful workloads are migrated as virtual machines from a larger number of resources to a smaller number of resources so as to eliminate workload from some resources. These latter resources can then be placed into a lower-power state to reduce power consumption. When workload rises again, some or all of the lower-powered resources can be powered-on, and workload can be reapplied to them.

### FIELD OF THE INVENTION

This invention relates to a method for power-aware workload balancing using virtual machine technology. More specifically, the invention relates to a method for load balancing of state-maintaining or stateless applications by migration of virtual machines from one server resource to another followed by reducing the power consumption of any evacuated physical resources, with the objective of minimizing the total power consumption of the set of physical resources.

### BACKGROUND OF THE INVENTION

In systems having multiple physical resources (i.e., computers) capable of performing work, it is often desirable to migrate work from one resource to another to achieve load balancing and uniform resource utilization. In general, the objective of such techniques is to spread the workload out equally across the multiple resources. Load balancing for such systems has a long history, with a very large related technical literature. Recent contributions to adaptive load balancing of a migratable web workload can be found in the article by J. Aman, C. K. Eilert, D. Emmes, Peter Yokum, and D. Dillenberger, entitled “Adaptive Algorithms for Managing a Distributed Data Processing Workload”, IBM Systems Journal, 36(2), 1997 and in an article by A. Iyengar, J. Challenger, D. Dias, and P. Dantzig, entitled “High-performance Web Site Design Techniques”, IEEE Internet Computing, 4(2):17-26, March 2000.

Migration of work across resources is also of interest in support of power management in such systems, but for very different reasons. When a system, having multiple resources which are capable of performing work is underutilized, the workload can often be aggregated from a larger number of resources onto a smaller number of resources in a process referred to as “load imbalancing.” Load imbalancing increases the utilization of the resources to which the workload is migrated, but removes all workload from some number of other resources, such that they can then be powered-off, hibernated, or otherwise placed into a low-power state, hence conserving energy. As workload ebbs and flows, resources can be unloaded and powered-off, or powered-on and loaded, respectively, in pursuit of some optimal tradeoff between meeting the workload demands, and minimizing power consumption.

Examples of recent contributions in the area of workload balancing with power management include the following articles: by P. Bohrer, E. Elnozahy, T. Keller, M. Kistler, C. Lefurgy, C. McDowell, and R. Rajamony, “The case for power management in web servers”, from Power-Aware Computing, (Kluwer/Plenum Series in Computer Science, January 2002); by J. Chase, D. Anderson, P. Thakar, A. Vahdat, and R. Doyle, “Managing energy and server resources in hosting centers”, from the 18^{th} symposium on Operating Systems Principles (SOSP), October 2001; by J. Chase and R. Doyle. “Balance of Power: Energy Management for Server Clusters” from the Proceedings of the 8^{th} Workshop on Hot Topics in Operating Systems, May 2001; and, by E. Pinheiro, R. Bianchini, E. V. Carrera, and T. Heat, “Load Balancing and Unbalancing for Power and Performance in Cluster-Based Systems, from the Workshop on Compilers and Operating Systems for Low Power, September 2001.

However, the prior art approaches of load balancing and load imbalancing are currently only feasible for workloads that are relatively stateless and that consist of tasks that are of short duration. Web serving workloads are examples of this type of workload. In these cases, a workload distributor, such as an “IP Sprayer”, can distribute requests to web servers based on web server utilization, to achieve a given load balancing policy as outlined above. Simplistically, the IP sprayer sends a given request to the server having the lowest utilization; and, in turn, the servers keep the IP sprayer updated with their utilization, response time, or other indications. Workload can be readily distributed across the server aggregate according to any given policy. The “sprayer” approach works quite well because a given request is locale-transparent. Assuming that all servers have access to the same backend source of web pages or database, as is common in practice, a request can be dispatched to any web server in the complex. Finally, the requests are short-lived enough that, if a given server is “condemned” and new workload is withheld from the condemned server, its utilization will quickly fall; whereas, if a new server is brought online, new workload can be readily dispatched to a new server and its utilization will quickly rise.

This is emphatically not the case for many other common classes of workloads, which are herein denoted as “stateful” workloads (i.e., workloads for which state must be maintained). None of the references cited above are able to migrate stateful workloads. Stateful workloads are those that possess a large amount of potentially unmigratable state tied to a given server or operating system instance or workloads that have longer-running tasks that cannot be terminated and restarted and cannot, therefore, be easily moved to another server that is less utilized. For stateful workloads, load balancing or imbalancing, either to achieve uniform resource utilization, or to achieve power minimization, cannot be performed.

What is desirable, therefore, and is an objective of the present invention, is to provide a general purpose method that allows the migration of an arbitrary workload, be it stateless or stateful, from one server to another.

### SUMMARY OF THE INVENTION

The foregoing and other objectives are realized by the present invention wherein the locale-independence of virtual machine technology is employed to facilitate load imbalancing in support of power management. Arbitrary workloads are migrated as virtual machines from a larger number of resources to a smaller number of resources so as to eliminate workload from some resources. These latter resources can then be placed into a lower-power state to reduce power consumption. When workload rises again, some or all of the lower-powered resources can be powered-on, and workload can be reapplied to them.

### BRIEF DESCRIPTION OF THE DRAWINGS

The foregoing and other objects, aspects, and advantages will be better understood from the following non-limiting detailed description of preferred embodiments of the invention with reference to the appended drawings wherein:

FIG. 1 provides a block diagram of a virtual machine configuration with load balanced in accordance with the prior art;

FIG. 2 provides a block diagram of the configuration of FIG. 1 after power-aware load balancing in accordance with the present invention;

FIG. 3 provides a representative process flow diagram for implementing the present invention; and

FIGS. 4A and 4B illustrate multiple VM migrations to achieve power-aware load balancing in accordance with the present invention.

### DETAILED DESCRIPTION OF THE INVENTION

Virtual Machine (hereinafter “VM”) technology can be combined with power management technology to reduce system power consumption. Virtual Machine technology gives each user or application the appearance of having sole control of all of the resources of a server system, while in fact allowing multiple users or applications to share a single physical resource without interfering with each other. VM technology can be implemented at the hardware level or at the software level, the implementations details of which do not affect the present invention. However implemented, VM technology abstracts the physical resources of a given server into one or more encapsulated, logically isolated operating system instances called virtual machines. To an application or user running within a VM, it seems as if the VM is running on a dedicated, stand-alone server. In effect, a single physical server is turned into multiple logical servers called virtual machines, which are completely isolated from each other. In addition, the underlying Virtual Machine technology provides the capability of fairly sharing the physical resources among the multiple virtual machines that are running on the physical resources.

By its nature, VM technology decouples an application's logical execution locale (i.e., its operating system, storage, networking, and other resources) from its physical execution locale (i.e., physical CPU, memory, networking components, and other physical resources). This decoupling and abstraction of the physical execution locale makes it possible for an application to run on any physical resource, provided that its virtual machine has been migrated to that physical resource. VM technology also offers the capability to suspend a VM and copy it to an associated application at a stable storage site, and subsequently restart that VM and associated application. Thus, using VM technology, operating system instances and associated applications can be freely distributed across a set of physical resources in pursuit of system optimization goals.

Assuming that a workload requires a certain number of separate virtual machines, perhaps for security or software error containment reasons, the virtual machines can be distributed arbitrarily across a set of resources according to some figure of merit, such as performance, in the same manner as a stateless workload. However, it is not simply the work request which is being distributed to a resource; rather, it is the actual virtual machine that is instructed to start at a resource. A “resource” may be a server, a cluster of servers, or another execution unit that is capable of running the VM software, and has its own power source. A blade center, or server farm of multiple servers with installed VM software, provides an environment having multiple server capacity in a single-chassis with a single point of contact. For clarity of explanation, hereinafter, a resource will collectively be referred to as a “server” and a blade center as a “multiple server configuration”.

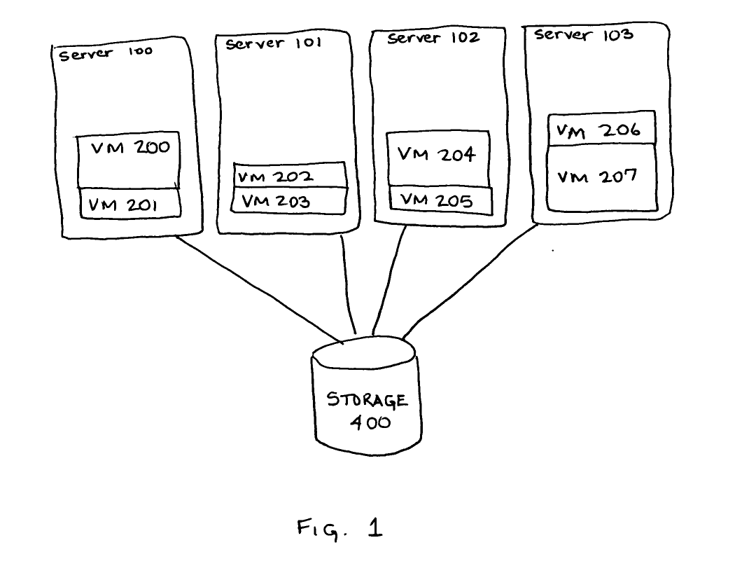

A multiple server configuration is shown in FIG. 1, having managed servers 100, 101, 102 and 103, each containing a plurality of VMs, 200-207. It is to be noted that all numerical quantities are for concreteness only and should not be construed as limiting the applicability of the invention. Accordingly, the ensuing description applies to any number of servers greater than one. The multiple server configuration of FIG. 1 includes a shared storage location 400 which is connected to each of the servers, from which the servers can access databases, etc. and at which servers can store data. The shared storage location can be local to the multiple server configuration or can be network based. Under a workload equalization approach to load balancing, as illustrated, the workload is distributed as evenly as possible across all of the servers, 100-103, in the multiple server environment, thereby assuring that no server is underutilized or overburdened. FIG. 1 shows how the eight VMs could be distributed across four machines to approximately equalize workload, where the height of each VM roughly indicates the amount of resources that it consumes on that machine.

The four physical resources, shown as managed servers 100-103 in FIG. 1, are managed by a management entity (not shown), which may be provided locally at one of the managed servers or at a remote location. The management entity tracks the utilization of the server resources and determines the optimal distribution of virtual machines across the servers to minimize power consumption while maintaining efficient execution of the workload. Based on its analysis, the management entity may direct one or more of the virtual machines to migrate to a different one of the managed servers while directing other managed servers to power down. If the management entity is located at one of the managed servers, clearly that managed server will not be chosen to power down. Under the present invention, the management entity determines the optimal distribution of virtual machines across the servers by evaluating the total resource utilization.

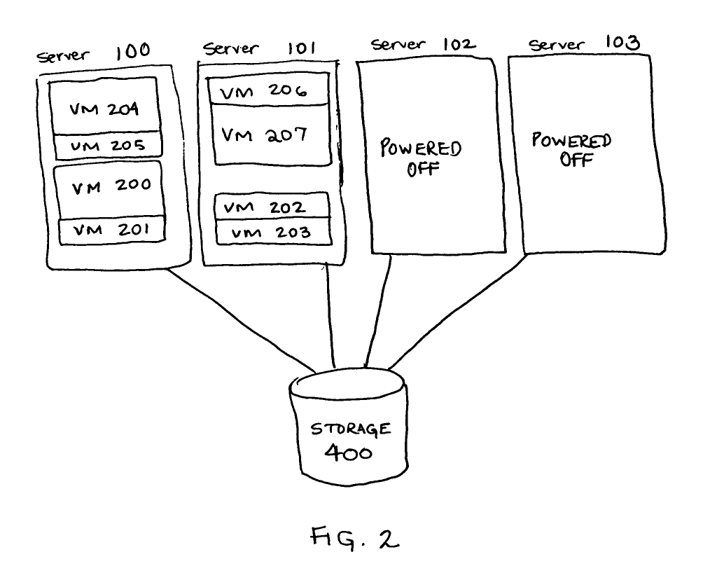

FIG. 2 illustrates the eight VMs, which had been distributed across the four servers to equalize workload in FIG. 1, redistributed in accordance with the invention in a power-aware fashion. FIG. 2 shows that, in order to accommodate the illustrated workload, only two servers need to be powered on. As illustrated, VMs 204-205 have been migrated from physical resource 102 to physical resource 100, and VMs 206-207 have been migrated from physical resource 103 to physical resource 101. As a result, physical resources 102 and 103 can be instructed to lower their power consumption, either to a reduced state or to an “off” state, resulting in a 50% reduction overall in power consumption.

If the servers have the capacity to support the performance needs of the condensed configuration, and there is no physical reason (such as hardware fault tolerance) that the VMs must be on separate servers, then power savings can be realized by aggregating VMs to the smallest possible complement of physical resources, and powering off the rest.

Because the workload's environment is totally virtualized, VM also facilitates load balancing and car readily respond to increased demand or to an increased number of VMs. For example, when the demand offered by the multiple VMs on a given configuration exceeds the capacity of the powered-on servers, another server can be powered-on and one or more VMs can be paused, migrated to the newly available server, and resumed.

The logical flow of the process implemented by the management entity is outlined below:

Step 1.

Measure the total utilization of all N powered-on resources in the group, as:

U(total)=Utilization(1)+Utilization(2)+ . . . Utilization(N), where

Utilization(i) is the utilization of physical resource i, and 0<Utilization(i)<1.

For example, if there are 5 powered-on resources in the group, then the calculation would be:

U(total)=Utilization(1)+Utilization(2)+Utilization(3)+Utilization(4)+Utilization(5), and 0<U(total)<5.

Step 2.

Calculate how many resources are required to support the workload. For example, if U(total)=2.5, indicating that two servers might be 100% utilized and one server might be 50% utilized, then 3 physical resources are needed to support the workload. Note that if the utilization is not an integer, then the number of servers required to meet this utilization must be rounded up to the next integral number to allow to the workload to be supported. In this case, one or more of the physical resources would not be 100% utilized.

Step 3.

If U(total)<N, then N-U(total) resources can be powered down. For example, if N=5 and U(total)=3, then 5−3=2 physical resources can be powered down, leaving 3 resources powered-on. The power-off sequence is as follows:

a. Select N-U(total) resources.

b. Command the virtual machines on those resources to halt processing and copy their state into a suspend file at the shared storage location.

c. Place the N-U(total) physical resources into a low-power state.

d. Fairly allocate the virtual machines to the remaining U(total) physical resources.

e. Command the suspended virtual machines to start on their allocated physical resources.

f. Set N to U(total) to indicate that the number of physical resources has decreased.

g. Return to Step 1.

Step 4.

If U(total) is close to N, then the system might be overutilized and additional physical resources might need to be powered on. For example, if N=5 and U(total) is close to 5, then additional physical resources might need to be turned on to accommodate potential future increases in workload. The power-on sequence is as follows.

a. Assume that one additional physical resource needs to be powered on and such additional physical resource is available. Select some number of virtual machines from among the N currently powered-on physical resources.

b. Command the virtual machines on those resources to halt processing and copy their state into a suspend file as outlined above.

c. Power on the new physical resource.

d. Command the suspended virtual machines to start on the new physical resources.

e. Set N to N+1 to indicate that the number of physical resources has increased.

f. Return to Step 1.

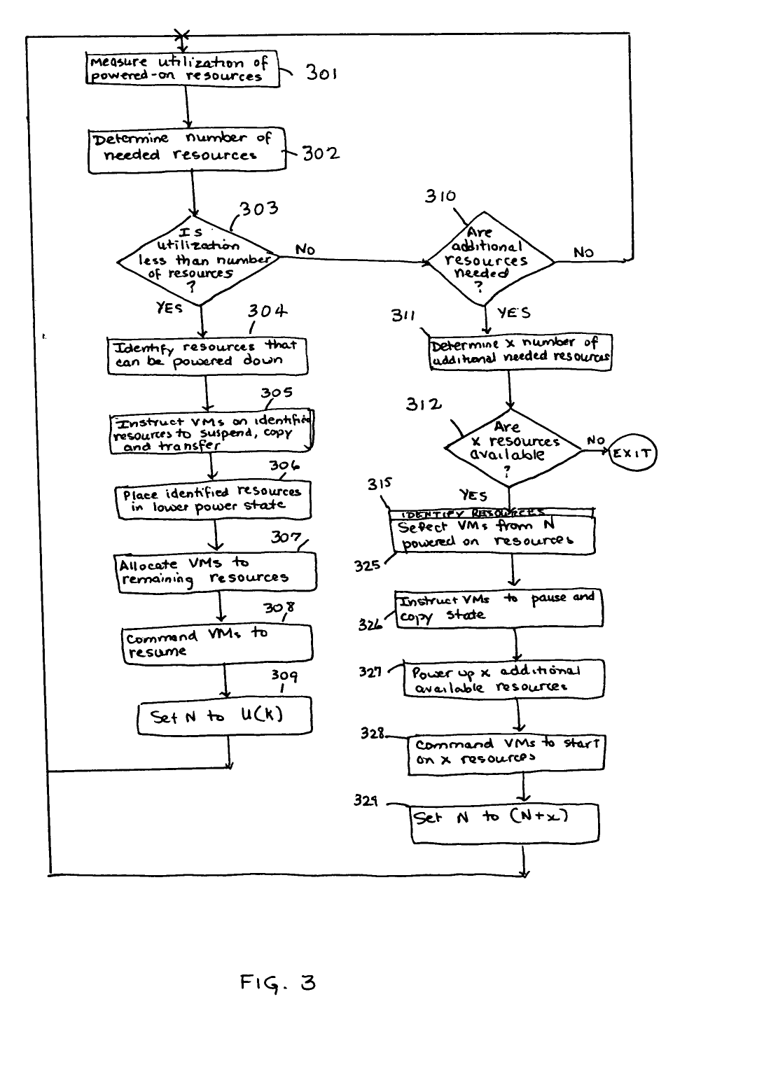

FIG. 3 provides a representative process flow for implementing the power-aware load balancing of the present invention. At step 301, the management entity measures the total utilization of all of the powered on resources. That total utilization value, U (total), represents the total amount of resources needed to implement all of the workload running on all of the virtual machines. Based on the total utilization, the number of needed resources N (i.e., number of resources required to support the workload) is determined at step 302. At step 303, it is determined whether the total utilization, or the number of needed resources, is less than the total number of powered on resources. If the total utilization is less than the number of powered on resources, then some resources can be powered down to conserve power overall. Based on a “yes” determination at step 303, therefore, the resources that can be powered down are identified at step 304. VMs which are running on the identified resources are then instructed, at step 305, to pause and to copy their entire state into a suspend file at the shared storage location. Once the VMs have been instructed to halt processing and copy their state, the identified resources can be placed in a lower power state (e.g., reduced power or off) at step 306. The VMs which have been suspended are then allocated to the remaining powered on resources, at 307, and are commanded to resume at the allocated resources in step 308. The number of powered on resources (N) is adjusted at step 309 and the process returns to step 301 at which utilization is monitored.

If it is determined, at step 303, that total utilization, U(total), is not less than the number of resources, then the management entity determines, at step 310, if additional resources are needed to be powered on. If the determination is “no”, such that an optimal relationship exists between the number of resources and the utilization thereof, then the process returns to step 301 at which utilization is monitored. If, however, it is determined that additional resources are needed, due to increased workload, the number of required additional resources, “x”, is calculated at step 311. At step 312 it is determined if, in fact, “x” additional resources are available, and the additional “x” resource or resources are identified at step 315. If “x” additional resources are not available, then this implies that all physical resources are powered on and are supporting the workload; and, that further workload will result in a system overload situation.

At step 325, VMs are selected to be migrated from the powered on resources to the x additional resource(s). The selected VMs are instructed at step 326 to pause and to copy their entire state into a suspend file at the shared storage location. Upon powering up of the additional resources), at step 327, the VMs are then commanded to start on the additional resource(s). The number of powered on resources, N, is then adjusted by x at step 329, and the process returns to monitor utilization at step 301.

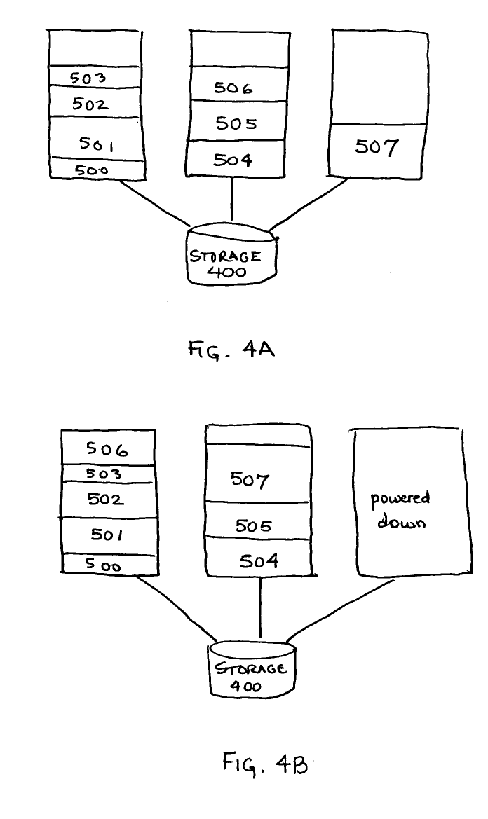

It is to be noted that the interruption of workload processing will be minimal since the migrating of virtual machines from one server will effectively require only the time it takes to copy state to storage and to read the state out from storage to the new server. Should multiple shifts in virtual machines be necessary, as depicted in FIGS. 4A and 4B, the increased workload processing time is trivially affected. As shown in FIG. 4A, it may be necessary to migrate virtual machines from a powered on server to another powered on server in order to accommodate the virtual machine or machines from a server which is to be powered off. As illustrated, managed servers 410, 420 and 430 contain virtual machines 500-507. Based on an analysis of the total utilization across the resources, it is clear that U(total) is less than the number of servers N. However, neither managed server 410 nor managed server 420 can handle VM 507 as they are currently operating. The solution that must be orchestrated by the management entity is to “juggle” the migrations of the VMs to optimize the load sharing in a power aware fashion. One way to accomplish that is to migrate VM 506 from managed server 420 to managed server 410, by instructing VM 506 to copy its state to the shared storage location 400 followed by instructing VM 506 to resume at managed server 410, and thereafter instructing VM 507 to suspend and copy its state to shared storage location 400 and thereafter instructing VM 507 to resume at managed server 420, allowing server 430 to power down. Clearly, VM 503 could alternatively have been migrated from server 410 to server 420, leaving adequate capability at server 410 to then migrate VM 507 from server 430 to server 410 and again allow server 430 to power down.

The invention has been described with specific reference to the illustrated embodiments. Clearly, modifications can be made by one having skill in the relevant art without departing from the spirit and scope of the appended claims.

1. A method of managing workload on a system comprising a plurality of resources each capable of supporting one or more virtual machines and at least one shared storage location, comprising the steps of:
calculating the number of needed resources required to support the current workload based on the total utilization of the resources currently powered on;
ascertaining the number of the available resources within said system;
determining the relationship between the number of needed resources and the number of available resources; and
performing steps to migrate at least one virtual machine from at least one physical resource to at least one other physical resource based on the relationship.

2. The method of claim 1 wherein said performing comprises instructing at least one virtual machine to migrate from its respective one of said plurality of available resources by halting processing at its respective one of said plurality of available resources, copying its entire state to said storage location, and resuming processing in at least one different resource of said plurality of available resources.

3. The method of claim 2 further comprising powering down at least one of said available resources from which said at least one virtual machine has been migrated after said copying when it is determined that the number of available resources exceeds the number of needed resources.

4. The method of claim 2 wherein said at least one different resource of said available resources had been powered down and additionally comprising the step of powering up said at least one different resource prior to said resuming of processing.

5. The method of claim 1 wherein said calculating the number of needed resources required to support the current workload comprises determining a utilization amount for each of the resources currently powered on and adding the utilization amounts together.

6. The method of claim 2 wherein said calculating the number of needed resources required to support the current workload comprises determining a utilization amount for each of the resources currently powered on and adding the utilization amounts together.

7. The method of claim 5 wherein the number of needed resources required to support a given workload as represented by a given total utilization is determined to be the smallest integral number larger than the total utilization.

8. The method of claim 6 wherein the number of needed resources required to support a given workload as represented by a given total utilization is determined to be the smallest integral number larger than the total utilization.

9. A program storage device readable by machine tangibly embodying a program of instructions executable by the machine for performing a method for managing workload on a system comprising a plurality of resources each capable of supporting one or more virtual machines and at least one shared storage location, said method comprising the steps of:
calculating the number of needed resources required to support the current workload based on the total utilization of the resources currently powered on;
ascertaining the number of the available resources within said system;
determining the relationship between the number of needed resources and the number of available resources; and
performing steps to migrate at least one virtual machine from at least one physical resource to at least one other physical resource based on the relationship.

10. The program storage device of claim 9 wherein said performing comprises instructing at least one virtual machine to migrate from its respective one of said plurality of available resources by halting processing at its respective one of said plurality of available resources, copying its entire state to said storage location, and resuming processing in at least one different resource of said plurality of available resources.

11. The program storage device of claim 10 wherein said method further comprises powering down at least one of said available resources from which said at least one virtual machine has been migrated after said copying when it is determined that the number of available resources exceeds the number of needed resources.

12. A processing workload management system comprising:
multiple physical resources capable of supporting one or more virtual machines; and
at least one power management component adapted to calculate the number of needed resources required to support the current workload based on the total utilization of the resources currently powered on, ascertain the number of the available resources within said system, determine the relationship between the number of needed resources and the number of available resources; and perform steps to migrate at least one virtual machine from at least one physical resource to at least one other physical resource based on the relationship.

13. The processing workload management system of claim 12 wherein said power management component instructs at least one virtual machine to migrate from its respective one of said plurality of available resources by halting processing at its respective one of said plurality of available resources, copying its entire state to said storage location, and resuming processing in at least one different resource of said plurality of available resources.

14. The processing workload management system of claim 12 wherein said power management component further instructs powering down at least one of said available resources from which said at least one virtual machine has been migrated after said copying when it is determined that the number of available resources exceeds the number of needed resources.

15. The processing workload management system of claim 12 wherein each of said multiple physical resources additionally comprises a resource power control component for dynamically adjusting power consumption by said physical resource.

16. The processing workload management system of claim 15 wherein said power management component instructs said resource power control component of at least one of said multiple physical resources to adjust its power consumption.

17. The processing workload management system of claim 13 wherein said power management component further instructs powering up of at least one resource of said available resources which had been powered down prior to said resuming of processing.

18. A power management component for managing workload on a system comprising a plurality of resources each capable of supporting one or more virtual machines and at least one shared storage location comprising:
a calculating component for calculating the number of needed resources required to support the current workload based on the total utilization of the resources currently powered on;
a detecting component for detecting the number of the available resources within said system;
a comparator component for determining the relationship between the number of needed resources and the number of available resources; and
a migration instruction component for performing steps to migrate at least one virtual machine from at least one physical resource to at least one other physical resource based on the relationship.

19. The power management component of claim 18 wherein said migration instruction component instructs at least one virtual machine to migrate from its respective one of said plurality of available resources by halting processing at its respective one of said plurality of available resources, copying its entire state to said storage location, and resuming processing in at least one different resource of said plurality of available resources.

20. The power management component of claim 18 wherein said migration instruction component further instructs powering down at least one of said available resources from which said at least one virtual machine has been migrated after said copying when it is determined that the number of available resources exceeds the number of needed resources.
